(19) United States
(12) Patent Application Publication
(10) Pub. No.: US 2014/0018173 A1
(43) Pub. Date: Jan. 16, 2014

(54) VIDEO GAME CONTROLLER WITH INTEGRATED TOUCHPAD

(71) Applicant: Ouya, Inc., Santa Monica, CA (US)

(72) Inventor: Julie Kane Urhman, Los Angeles, CA (US)

(21) Appl. No.: 13/939,102

(22) Filed: Jul. 10, 2013

Related U.S. Application Data
(60) Provisional application No. 61/670,112, filed on Jul. 10, 2012.

(51) Int. Cl. A63F 13/06

(52) U.S. Cl. CPC A63F 13/06
USPC 463/37

(57) ABSTRACT

A video game controller for use with a video game console allows a player to control a video game. The video game controller includes an enclosure having an outer surface including a removable faceplate and a non-removable surface. The non-removable surface is formed with a non-touch sensitive surface and a touch sensitive surface. The touch sensitive surface is configured to receive a touch input from a player. The touch sensitive surface is substantially flush with the non-touch sensitive surface. The video game controller also includes a number of actuators for receiving player input. Each actuator protrudes through an opening in the outer surface. The controller is configured to communicate touch input from the touch sensitive surface and actuator input from the actuators as control information to the video game console.

### TECHNICAL FIELD

Disclosed embodiments relate generally to video game systems, and particularly to video game controllers.

### BACKGROUND

One way of playing video games involves a video game system including a television with speakers, a video game console, and a video game controller. The video game console includes computer software and computer hardware for operating a video game. The console is communicatively coupled to the television and speakers to present the video game so that the player can hear and see the video game. The console is also communicatively coupled to a video game controller with numerous input actuators that the player uses to interact with and control the presented video game.

### SUMMARY

A video game controller for use with a video game console allows a player to control a video game. The video game controller includes an enclosure having an outer surface including a removable faceplate and a non-removable surface. The non-removable surface is formed with a non-touch sensitive surface and a touch sensitive surface. The touch sensitive surface is configured to receive a touch input from a player. The touch sensitive surface is substantially flush with the non-touch sensitive surface. The video game controller also includes a number of actuators for receiving player input. Each actuator protrudes through an opening in the outer surface. The controller is configured to communicate touch input from the touch sensitive surface and actuator input from the actuators as control information to the video game console.

### BRIEF DESCRIPTION OF THE DRAWINGS

FIG. 1 is an illustration of a video game system according to one embodiment.

FIG. 2 is a front left top perspective view of a video game controller according to one embodiment.

FIG. 3 is a front elevational view of a video game controller according to one embodiment.

FIG. 4 is a top elevational view of a video game controller, according to one embodiment.

FIG. 5 is a side elevational view of a video game controller, according to one embodiment.

FIG. 6 is a top elevational view of a video game controller absent removable faceplates, thereby exposing an inner surface of the video game controller, according to one embodiment.

FIG. 7 is a top elevation view of a pair of removable faceplates that have been removed from a video game controller, according to one embodiment.

FIG. 8 is an exploded view of a video game controller, according to one embodiment.

FIG. 9 is a reverse view of the back of the front surface of the video game controller, exposing the components of the touch sensitive surface, according to one embodiment.

### DETAILED DESCRIPTION

### Video Game System Overview

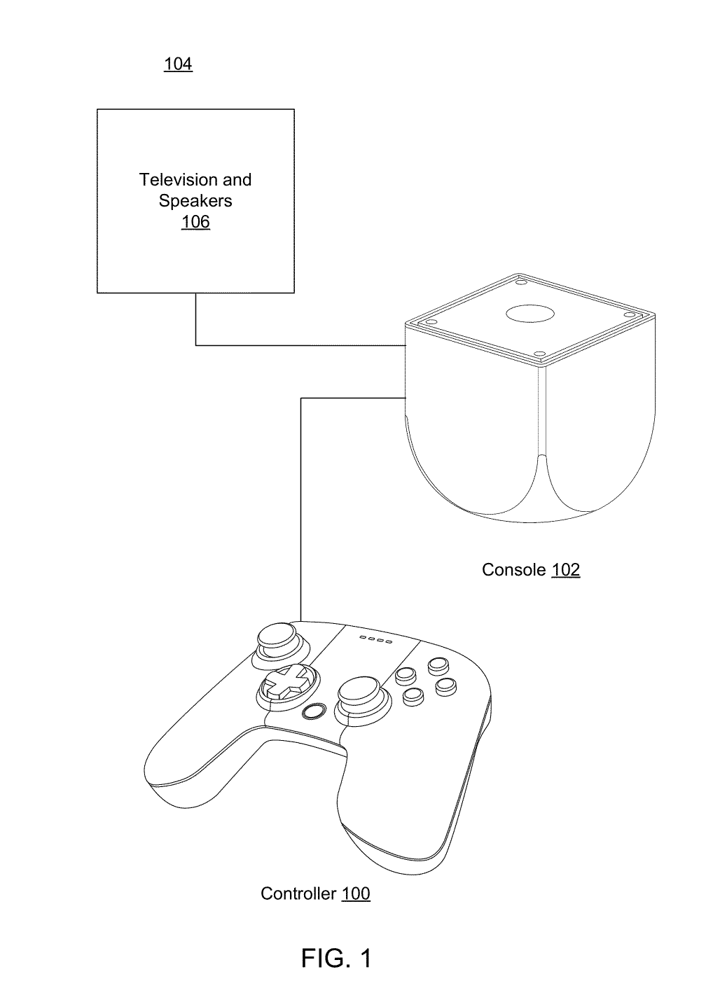

FIG. 1 is an illustration of a video game system 104, according to one embodiment. The video game system 104 includes a television and audio speakers 106, a video game console 102 a video game controller 100. The console 102 is communicatively coupled in either a wired (e.g., using the High-Definition Multimedia Interface or HDMI™) or wireless configuration (e.g., using Bluetooth™) to the television and speakers 106. The console 102 is also communicatively coupled to one or more controllers 100, usually in a wireless configuration (e.g., Bluetooth™), however wired implementations are also envisioned. The console is capable of being coupled simultaneously to multiple controllers 100 via either wired or wireless communication. The video game console 102 is configured to assign a controller identity to each connected controller 100 so that commands delivered by each connected controller are distinguishable from commands delivered by the other connected controllers, and in embodiments in which the controllers receive communication from console 102, so that the controllers 100 are separately addressable.

The video game console 102 is a computer system including computer software and computer hardware for operating video games. With respect to computer hardware, the console 102 may include, for example, one or more of each a central processing unit (CPU), system memory (e.g., random access memory or RAM), persistent data storage, an input/output (I/O) device interface, an I/O device for communicating with the television and speakers 106 and controller/s 100, an interconnect bus, and a network interface for communicating with external computing systems.

The CPU retrieves and executes an operating system, a user interface, and video games themselves based on data stored in the memory and persistent storage More generally, the CPU controls and coordinates operations of other system components. The interconnect bus is used to transmit programming instructions and application data between the CPU, I/O devices interface, storage, network interface, and memory. The persistent storage generally consists of fixed storage devices such as fixed hard disk drives including both plate disc drives and solid state drives (SSDs), however in some instances data may be stored externally to the console 102 and accessed through the network interface. The I/O devices are communicatively coupled to the television and speakers 106 and controller 100.

The console 102 uses the network interface to download software updates for the console's operating system and user interface, to download games and game updates for play using the console, and to download and upload player information including high scores earned, account information, multiplayer game information, and game purchase transaction information. The network interface may also be used to coordinate and carry out multi player games between different players each using a different video game system 104, and who are communicatively coupled together through the network interface. The network interface communicatively couples in either a wired (e.g., Ethernet) or wireless (e.g., using hardware configured to implement the 802.11 technology) manner to an external computing system such as the Internet, which may also include intermediary wide area networks (WANs), local area networks (LANs). These types of external computer system network connections are merely exemplary, however, as a wide range of inter-computer network technologies may be used to implement these features.

With regard to computer software, the console 102 includes an operating system, a user interface, and one or more video games. The user interface includes a menu for selecting games to play, for demoing, purchasing, and downloading games for play, for configuring games prior to play, for managing player account information, for viewing player high scores, in-game achievements, and for configuring the settings of the console with respect to audio, video, and controller preferences.

Generally, software on the console 102 controls what is displayed on the television and what is heard through the speakers 106. The software is configured to respond to inputs from the controller 100. The controller 100 controls the operation of the console 102 based on commands input to the controller 100 by the player. Based on the commands, the console 102 changes the execution of the software, which changes what is displayed on the television or heard through the speakers 106. Additionally, the console 102 is configured to communicate some information to the controller. For example, the controller 100 may include one or more light emitting diodes (LEDs) for displaying a status of the console, and may also include a vibration mechanism for providing the player physical feedback during game play.

### Video Game Controller Overview

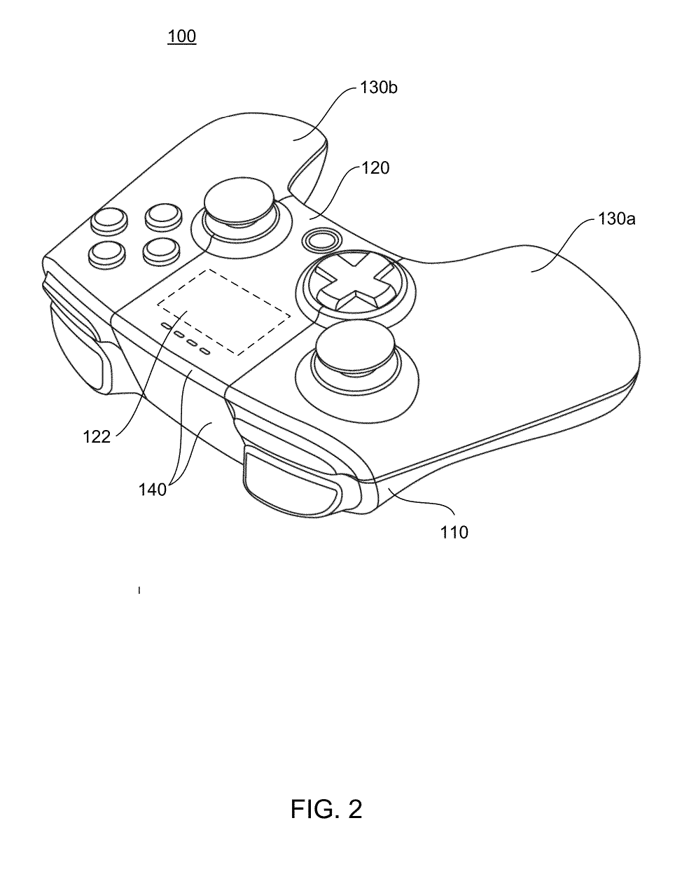

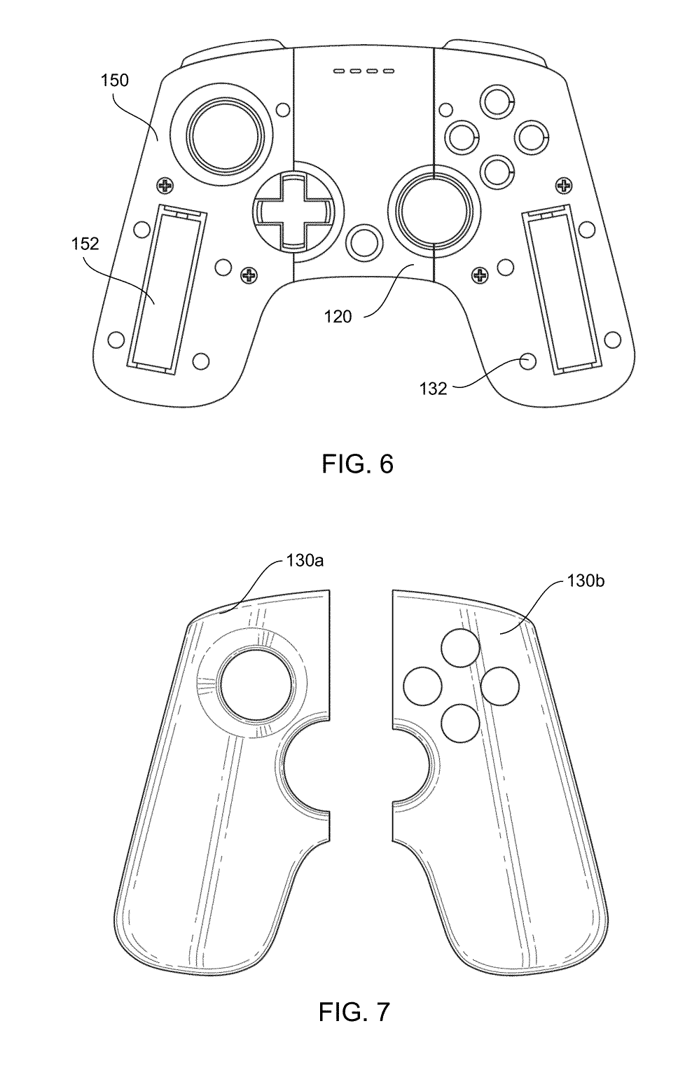

FIG. 2 is a front left top perspective view of a video game controller 100, according to one embodiment. The controller 100 includes an enclosure 110. The enclosure 110 encases circuitry (not shown) configured to receive player input and to communicate with the console 102. The controller 100 receives player input through several different types of actuators that protrude through openings in the outer surface of the enclosure 110 and that are electrically coupled to the circuitry. The outer surface includes a number of different portions, including a trigger surface 140 and a front surface, itself including both a non-removable surface 120 and at least one removable faceplate 130 surface, here illustrated as removable faceplates 130a and 130b. Beneath the removable faceplates, the enclosure includes an inner surface, illustrated in FIG. 6 as inner surface 150. The controller also receives player input through a touch-sensitive surface 122 embedded within non-removable surface 120.

As introduced above, the actuators protrude through openings in the outer surface. The actuators are physically coupled to the enclosure 110 beneath the outer surface. Each actuator includes a physical mechanism for receiving manual input from a player. Each actuator further includes a corresponding electronic mechanism for translating received manual input an analog or digital electrical signal for input to the controller's circuitry. The controller 100 may include a number of different kinds of actuators, including analog sticks, directional controllers, and buttons of various constructions.

The circuitry enclosed within the controller 100 may vary depending upon the implementation. In one embodiment, the circuitry includes a CPU, field programmable gate array (FPGA), application specific integrated circuit (ASIC), or other processing device, a memory and/or a persistent data storage, and I/O circuitry. The I/O circuitry receives analog and/or digital player input from the actuators and communicates it to the CPU and memory/data storage. After processing, the CPU communicates the player input to the console using the I/O circuitry. In implementations where the controller 100 is wirelessly coupled to console 102, the enclosure 110 includes electrical couplings and cavities for insertion of one or more batteries. In implementations where the controller physically coupled to the console 102 via a wire, the wire may also transfer power to the controller 100 in addition to console 102 data.

### Video Game Controller Front Surface

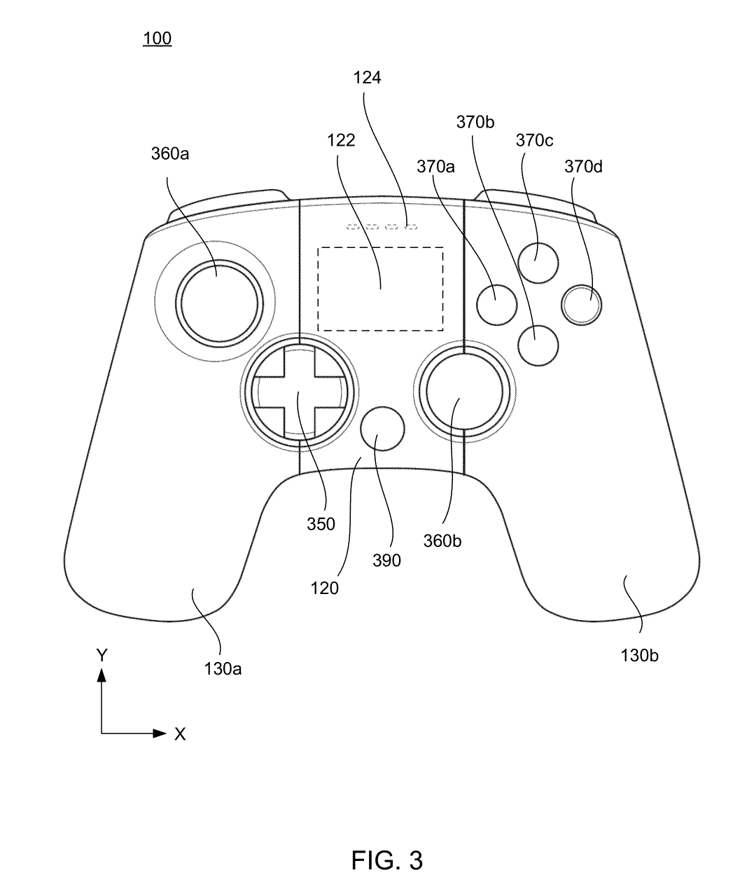

FIG. 3 is a front elevational view of a video game controller, according to one embodiment. The controller includes shaped left and right handles (not separately labeled) configured to be comfortably held by the player's left and right hands, respectively. The handles are ergonomically shaped to conform to a player's hands and positioned on the controller 100 such that the player may easily access the actuators on the front surface with their thumbs and the actuators on the trigger surface 140 with their other fingers.

FIG. 3 also includes an X-Y axis for sake of convenience in describing the relative locations of the actuators on the front surface. The X-Y axis is described with respect to the left and right sides of the controller relative to an arbitrary center point of the controller 100. Generally, it is envisioned that the left side of the controller 100 will be held and manipulated using the player's left hand, and the right side of the controller 100 will be held and manipulated by the player's right hand.

FIG. 3 illustrates various examples of actuators and their openings in the outer surface. In the illustrated embodiment of controller 100, the actuators include one directional pad 350, two analog sticks 360a-b, four action buttons 370a-d, and one start button 390. The openings corresponding to each actuator listed above include a directional pad opening, two analog stick openings, four action button openings, two trigger button openings, and one start button opening. For clarity, these openings are not separately labeled. The clearance on the openings relative to the button is sufficiently wide as to allow smooth travel of each actuator throughout its range of motion without impingement by the outer surface. Each opening in the outer surface may also include a bezel. The bezel may constrain the range of motion of the actuator protruding through that opening. Other embodiments of the controller 100 with different types of actuators and different numbers of each type of actuator are also envisioned.

Positioned upward along the Y axis and left along the X axis from the center point of the controller 100 is the left analog stick 360a. The left analog stick 360a is entirely surrounded by the first removable faceplate 130a. Positioned downward along the Y axis and to the right along the X axis from the left analog stick 360a is the directional pad 350. The directional pad is partially surrounded by the left removable faceplate 130a and partially surrounded by the non-removable surface 120.

Positioned to the right along the X axis from the directional pad 350 is the start button 390. The start button 390 is entirely surrounded by the non-removable surface 120. Positioned upward along the Y axis and to the right along the X axis from the start button 390 is the right analog stick 360b. The right analog stick 360b is partially surrounded by the non-removable surface 120 and partially surrounded by the right removable faceplate 130b. Positioned upward along the Y axis and to the right along the X axis from the second analog stick 360b are the four action buttons 370a-d. The action buttons 370a-d are entirely surrounded by the right faceplate 130b.

Regarding the individual action buttons 370 specifically, the action buttons 370 are uniformly spaced from each other in a cross configuration relative to the illustrated X-Y axis. Around a center point (not separately labeled), first action button 370a is positioned to the left and the fourth action button 370d is positioned to the right along the X axis relative to the center point. The second action point 370b is positioned downward and the third action button 370c is positioned upward along the Y axis relative to the center point.

The actuators on the front surface are positioned such that actuators located on the left side of the start button 390 along the X axis are generally intended to be operated by the thumb of the left hand of the player. The actuators on the right side of the start button 390 along the X axis are generally intended to be operated by the thumb of the right hand of the player. The start button is generally intended to be comfortably reached by either thumb. Other hand positions for using the controller 100 are also possible.

The directional pad 350 includes a molded surface physically coupled to a multi-directional switch for providing input to the controller circuitry. The directional pad surface is a generally cross-shaped button made from a rigid material such as molded plastic. The player manipulates the directional pad surface in one or two of four directions to tilt activate one or two of the directions of the multi-directional switch. The input received by controller circuitry is dependent on the direction chosen. In a neutral state with no player input, the directional pad surface rests in a default position, typically a central position to which the directional pad surface is resiliently biased.

The first and second analog sticks 360a-b include a circular pad at the end of the stick coupled to an analog switch. The analog stick and pad may be made from a rigid material such as molded plastic, and the analog switch may include one or more potentiometers. The circular pad may include a textured coating for increased traction between the pad and the player's thumb. The input to the controller circuitry is dependent on the degree of deflection of analog stick relative to a default position, as well as the orientation of the deflection. The default position is typically a center position to which the protrusion is resiliently biased.

In one embodiment, the analog stick may be tilted away from the default position along some combination of the X and Y axes. An X axis potentiometer measures the X axis deflection, and a Y axis potentiometer measures the Y axis deflection. Together, these measurements provide a total deflection and an orientation of that deflection. Either the raw potentiometer measurements or the total deflection and orientation may be provided as input to controller circuitry. The analog sticks 360 also have a ‘click’ feature. The player may depress or release the analog stick 360 in towards the enclosure 110 activating a separate pressure-sensitive switch. Activation of this separate switch may be provided as another input to the controller circuitry.

Each of the action buttons 370a-d and the start button 390 is a pressure sensitive switch for providing input to the controller circuitry. The action buttons may be made from a rigid material, such as molded plastic. Responsive to a player depressing or releasing an action button, the pressure-sensitive switch is activated, thereby sending an input to the controller circuitry.

FIG. 3 also illustrates the touch sensitive surface 122 and one or more LEDs 124 included as part of the non-removable surface 120. The touch sensitive surface is positioned in one embodiment between the left analog stick 360a and the action buttons 370a-d, and is centered above the start button 390. In one embodiment, the touch sensitive surface 122 is entirely surrounded by and formed using the non-removable surface 120. Generally, the non-removable surface 120 may be subdivided into two portions, the touch sensitive surface 122 portion, and the non-touch sensitive surface portion (not separately labeled). These different portions of the non-removable surface may be flush with each other and the two may also be visually indistinguishable as well.

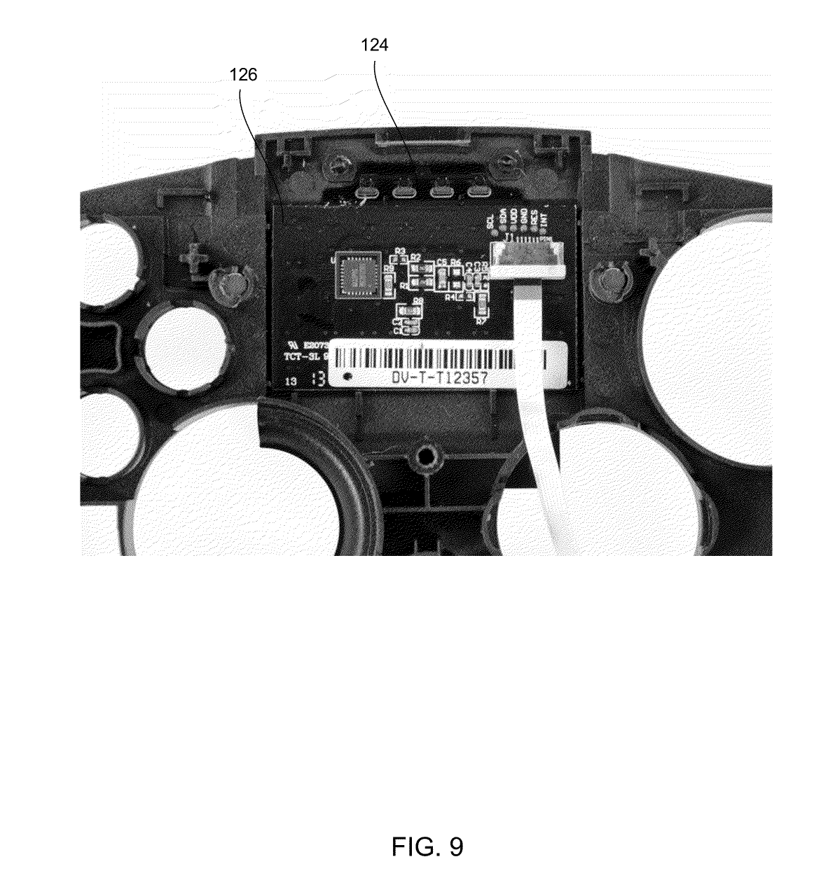

FIG. 9 is a reverse view of the back of the front surface of the video game controller, exposing the components 126 of the touch sensitive surface 122, according to one embodiment. This example illustrates that the components 126 making up the touch sensitive surface 122 may be situated directly beneath the non-removable surface 120.

In another embodiment (not illustrated), the touch sensitive surface 122 extends across the entire lateral extent of the non-removable surface 120 along the X axis between the removable faceplates 130, thus subdividing the non-touch sensitive portion of the non-removable surface 120 into at least two portions. As in the above embodiment, the touch sensitive surface 122 may be flush with the non-touch sensitive portion, and the two may also be visually indistinguishable as well. Further, in this embodiment, the touch sensitive surface 122 may be flush with the removable faceplates 130, and the two may also be visually indistinguishable as well.

The touch sensitive surface 122 receives touch input from the player and provides that input to the controller circuitry. The touch sensitive surface may be constructed using a capacitive touch sensitive mechanism including the touch sensitive surface 122 portion of the non-removable surface 120 as well as additional circuitry embedded beneath that surface. In other embodiments, other touch sensing mechanisms may be used including, for example, optical or resistive touch sensing mechanisms. The touch sensing mechanism may detect a number of different types of touch inputs, including the location of a touch, the direction motion of a touch, the speed and acceleration of a touch input, and the duration of a touch input, among others.

The controller may also include one or more light emitting diodes (LEDs) or other similar light sources. In one embodiment, these LEDs 124 are centered above the touch sensitive surface 124 along the Y axis. The LEDs may indicate the status of the console 102, the status of the controller 104, or other information. Examples of information provided by the LEDs include whether the controller 100 is powered on, whether the controller is connected to a console 102, the controller identity, and the charge status of the battery.

### Video Game Controller Top Surface

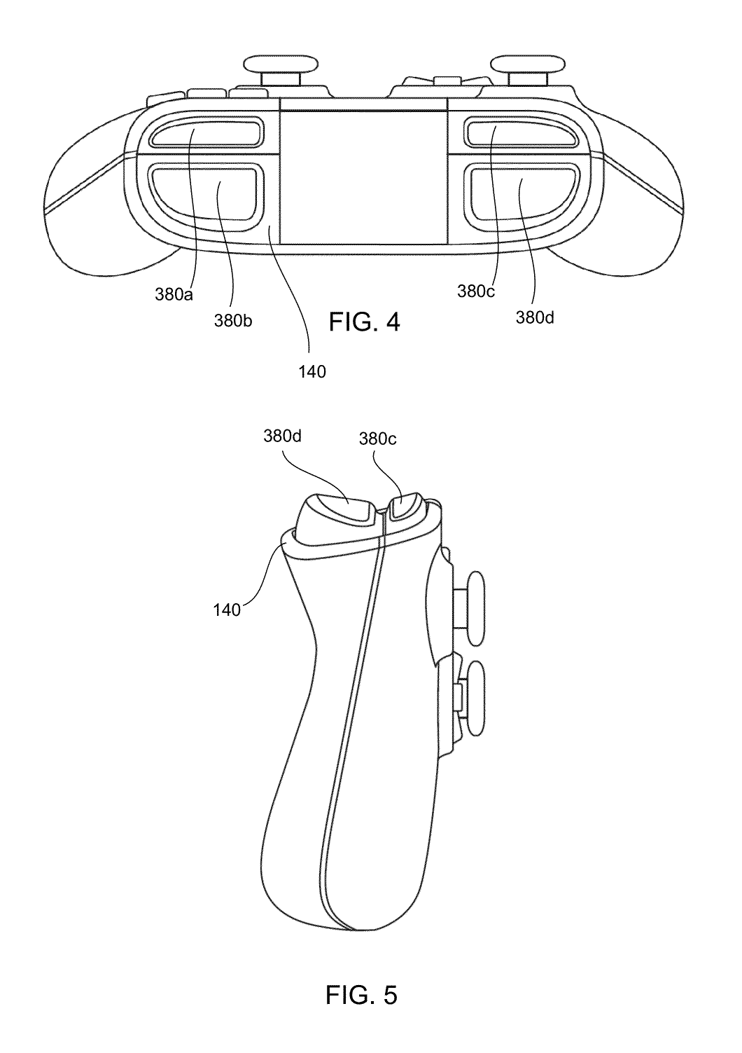

FIG. 4 is a top elevational view of a video game controller 100, according to one embodiment. FIG. 5 is a side elevational view of a video game controller, according to one embodiment. FIGS. 4 and 5 illustrate the trigger surface 140 and four trigger buttons 380a-d protruding through openings in the trigger surface 140, though in other embodiments additional or fewer trigger buttons may be used. The trigger buttons are positioned such that there are two trigger buttons per side of the controller. Specifically, two trigger buttons 380a and 380b are located on the right half of the controller and are generally envisioned to be operated by a player's right hand. Similarly, two trigger buttons 380c and 380d are located on the left half of the controller and are generally envisioned to be operated by the player's left hand.

The two trigger buttons are arranged in a stacked configuration such that one button is proximately located to the front surface relative to the other button on that side. Specifically, the first trigger button 380a is located proximately to the front surface relative to the second trigger button 380b. Similarly, the third trigger button 380c is located proximately to the front surface relative to the fourth trigger button 380d.

Each of the trigger buttons 380a-d is a pressure sensitive switch for providing input to the controller circuitry, similarly to the start button 390 and action buttons 370a-d. The trigger buttons 380 may be made from a rigid material, such as molded plastic. Responsive to a player depressing or releasing a trigger button, the pressure-sensitive switch is activated, thereby sending an input to the controller circuitry. The trigger buttons 380a-d may differ from each other and from the start 390 and action buttons 370a-d in shape, size, direction of motion under pressure, distance of travel until activation, and sensitivity to applied pressure. In one embodiment, the first 380a and third 380c trigger buttons are the same as each other except that they are shaped so as to be mirror opposites of each other. These two buttons differ from the second 380b and fourth 380d trigger buttons, which themselves are the same as each other except that they are shaped so as to be mirror opposites of each other.

### Removable Faceplates and the Inner Surface of the Controller

FIG. 6 is a top elevational view of a video game controller 100 absent removable faceplates 130a and 130b, thereby exposing an inner surface 150 of the video game controller, according to one embodiment. FIG. 7 is a top elevation view of a pair of removable faceplates 130a and 130b that have been removed from a video game controller 100, according to one embodiment.

The removable faceplates 130 are configured to be flush with the non-removable surface 120 when attached to the enclosure 110. The coupling mechanism for removably attaching the removable faceplates 130 may vary between implementations. In one embodiment, the attaching mechanisms includes a series of magnets, an example of which is magnet 132, embedded in the enclosure 110. These magnets line up with a magnetic material attached to the removable faceplates (e.g., iron screws, not shown), which when placed into contact with the magnets creates a non-negligible force for holding the removable faceplates in place. In one embodiment, the faceplates can be removed by hand.

Players may swap removable faceplates 130, providing a market for varying faceplates 130. These different faceplates may different decorative (e.g., color, pattern, design) or functional (e.g., surface texture) characteristics. For example, faceplates 130 may illustrate graphics from favored games, or the like.

In a wireless implementation, batteries may be inserted into and removed from battery cavities 152, which are accessible via openings in the inner surface 150 once the removable faceplates 130 have been removed.

### Exploded View

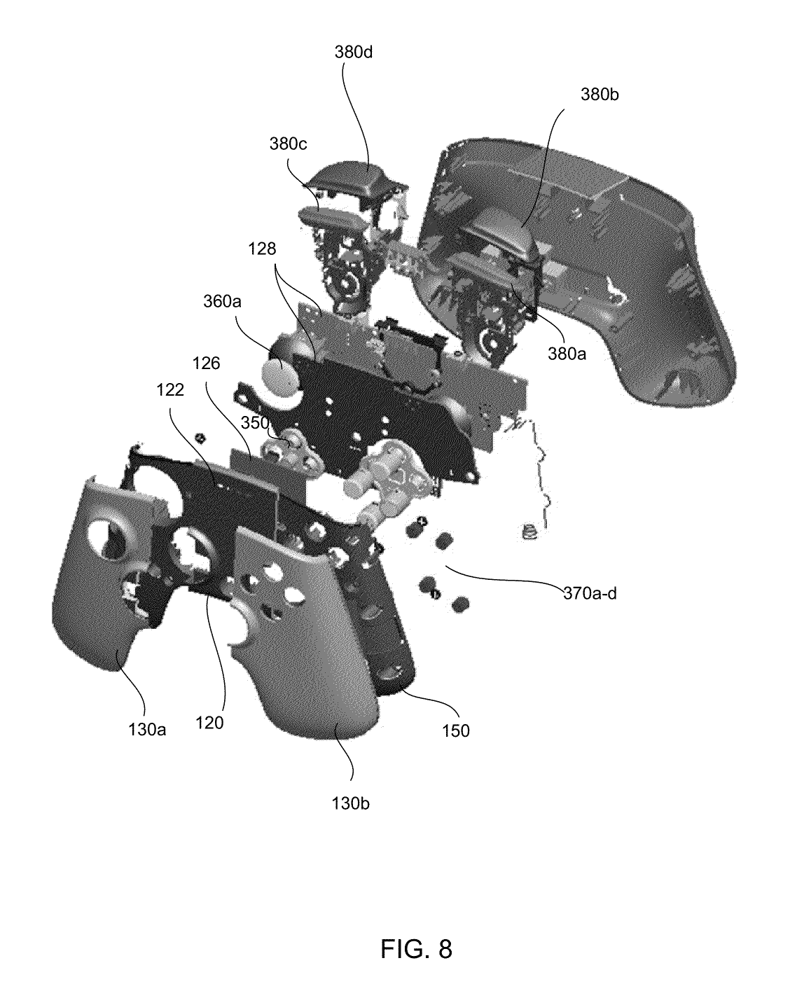

FIG. 8 is an exploded view of a video game controller, according to one embodiment. Specifically, FIG. 8 illustrates both the touch-sensitive surface 122 within the non-removable surface 120, as well as the components 126 of the touch sensitive surface 122 directly coupled beneath the non-removable surface 120. FIG. 8 also illustrates a printed circuit board (PCB) including the controller's circuitry 128.

### Additional Considerations

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Unless specifically stated otherwise as apparent from the following discussion, it is appreciated that throughout the description, discussions utilizing terms such as “processing” or “computing” or “calculating” or “determining” or the like, refer to the action and processes of a computer system, or similar electronic computing device, that manipulates and transforms data represented as physical (electronic) quantities within the computer system memories or registers or other such information storage, transmission or display devices.

The foregoing description of the embodiments of the invention has been presented for the purposes of illustration and description. It is not intended to be exhaustive or to limit the invention to the precise forms disclosed. Persons skilled in the relevant art can appreciate that many modifications and variations are possible in light of the above teaching. In particular, many variations and specific design choices can be made to the specific embodiments of the video game controller and console described herein without departing from the inventive concepts. It is therefore intended that the scope of the invention be limited not by this detailed description, but rather by the claims appended hereto.

What is claimed is:

1. A video game controller comprising:
an enclosure having an outer surface including a removable faceplate and a non-removable surface, the non-removable surface comprising a non-touch sensitive surface and a touch sensitive surface configured to receive a touch input from a player, the touch sensitive surface being substantially flush with the non-touch sensitive surface;
a plurality of actuators for receiving player input, each actuator protruding through an opening in the outer surface.

2. The video game controller of claim 1 further comprising:
an inner surface covered by the removable faceplate when the removable faceplate is coupled to the controller, and exposed when the removable faceplate is decoupled from the controller.

3. The video game controller of claim 2 wherein the inner surface comprises a coupling mechanism for removably coupling the removable faceplate.

4. The video game controller of claim 3 wherein the inner surface comprises a battery cavity.

4. The video game controller of claim 1 wherein the touch sensitive surface is also substantially flush with the removable faceplate.

5. The video game controller of claim 1 wherein the removable faceplate covers at least a portion of the outer surface of the enclosure.

6. The video game controller of claim 1 wherein the removable faceplate is substantially flush with the non-removable surface.

7. The video game controller of claim 1 wherein the video game controller comprises circuitry for processing the player input and the touch input, and for communicating with a physically separate video game console.

8. The video game controller of claim 1, further comprising a directional pad protruding through an opening formed at a junction of a left removable faceplate and the non-removable surface.

9. The video game controller of claim 8, further comprising a right analog stick protruding through an opening formed at a junction of the removable faceplate and the non-removable surface.

10. The video game controller of claim 1, further comprising a left analog stick protruding through an opening in a left removable faceplate.

11. The video game controller of claim 1, further comprising a start button protruding through an opening in the non-removable surface.

12. The video game controller of claim 1, further comprising a plurality of action buttons protruding through a plurality of openings in the removable faceplate.

13. The video game controller of claim 1, further comprising a plurality of light emitting diodes (LEDs) visible through the non-removable surface, the LEDs configured to activate based on a console status received from a physically separate video game console.

14. The video game controller of claim 1 further comprising:
a left removable faceplate;
a left handle at least partially covered by the left removable faceplate; and
a right handle at least partially covered by the removable faceplate.

15. The video game controller of claim 1 further comprising:
a trigger surface comprising a plurality of openings; and
a plurality of trigger actuators also configured to receive player input, the trigger actuators protruding through the trigger surface.
